(19) United States
(12) Patent Application Publication
(10) Pub. No.: US 2025/0305937 A1
(43) Pub. Date: Oct. 2, 2025

(54) DIAGNOSTIC SYSTEM INCLUDING A BASE AND SINGLE-USE FLUIDIC DISPOSABLES

(71) Applicants: UNIVERSITY OF WASHINGTON, Seattle, WA (US); UBIDX, INC., Redmond, WA (US)

(72) Inventors: Paul YAGER, Seattle, WA (US); Katherine SHARADIN, Redmond, WA (US); Alexander Richard JOSEPH, Seattle, WA (US); Benjamin David HOPKINS, Seattle, WA (US); Christopher Edward HARM, Seattle, WA (US); Hong Choo TANG, Seattle, WA (US); Robert RUDOLF, Seattle, WA (US); Lai Chiu LEWIS, Seattle, WA (US); Steven BENNETT, Seattle, WA (US); Kevin JIANG, Seattle, WA (US)

(73) Assignees: UNIVERSITY OF WASHINGTON, Seattle, WA (US); UBIDX, INC., Redmond, WA (US)

(21) Appl. No.: 18/864,940

(22) PCT Filed: Jun. 9, 2023
(86) PCT No.: PCT/US2023/068227

§ 371 Date: Nov. 12, 2024

Related U.S. Application Data
(60) Provisional application No. 63/351,733, filed on Jun. 13, 2022.

(51) Int. Cl. G01N 21/03; B01L 1/00; B01L 3/00

(52) U.S. Cl. CPC G01N 21/03; B01L 1/52; B01L 3/502715; B01L 3/5029; B01L 2200/025; B01L 2200/10; B01L 2200/16; B01L 2300/0654; B01L 2400/0683; G01N 2021/0321

(57) ABSTRACT

A diagnostic system for analyzing an analyte is described. In an embodiment the diagnostic system includes a fluidic single-use disposable and a base cooperatively coupleable thereto. In an embodiment, the fluidic single-use disposable comprises a sample processing subcomponent configured to receive a sample and emit signal light if the sample comprises an analyte; a fluidic single-use disposable housing encompassing the sample processing subcomponent, the fluidic single-use disposable housing comprising: a first major side; and a fluidic single-use disposable viewing window disposed in the first major side and positioned to allow light emitted from the sample processing subcomponent to pass through the fluidic single-use disposable viewing window. In an embodiment, the base comprises a base housing comprising: a first major side shaped to cooperatively couple with the first major side of the fluidic single-use disposable housing.

### CROSS-REFERENCE TO RELATED APPLICATION

This application claims the benefit of priority to U.S. Patent Application No. 63/351,733, filed on Jun. 13, 2022: the contents of which are hereby incorporated by reference in their entirety for all purposes.

### SUMMARY

In an aspect, the present disclosure provides a diagnostic system for analyzing an analyte. In an embodiment, the diagnostic system comprises a fluidic single-use disposable comprising: a sample processing subcomponent configured to receive a sample and emit signal light if the sample comprises an analyte: a fluidic single-use disposable housing encompassing the sample processing subcomponent, the fluidic single-use disposable housing comprising: a first major side: and a fluidic single-use disposable viewing window disposed in the first major side and positioned to allow light emitted from the sample processing subcomponent to pass through the fluidic single-use disposable viewing window: and a base comprising: a base housing comprising: a first major side shaped to cooperatively couple with the first major side of the fluidic single-use disposable housing: a base viewing window disposed in the first major side positioned to allow light emitted from the fluidic single-use disposable viewing window to pass through the base viewing window when the fluidic single-use disposable is cooperatively coupled to the base: a photodetector positioned to receive light emitted through the base viewing window and configured to generate a detection signal based on light received by the photodetector through the base viewing window: and a light source configured to emit illumination light through the base viewing window for receipt by the processing subcomponent on the fluidic single-use disposable: and a controller operatively coupled to the photodetector and the light source, the controller including logic that, when executed by the controller, causes the diagnostic system to perform operations including: emitting light with the light source: and generating a detection signal with the photodetector based on light received through the base viewing window.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of the subject matter disclosed herein will become more readily appreciated as the same become better understood by reference to the following detailed description, when taken in conjunction with the accompanying drawings, wherein:

FIG. 1A is an illustration of a diagnostic system according to an embodiment of the present disclosure:

FIG. 1B is a schematic illustration of a diagnostic system according to an embodiment of the present disclosure:

FIG. 2A is a perspective illustration of a fluidic single-use disposable according to an embodiment of the present disclosure:

FIG. 2B is another perspective illustration of the fluidic single-use disposable of FIG. 2A according to an embodiment of the present disclosure;

FIG. 2C is an exploded view of the fluidic single-use disposable of FIG. 2A according to an embodiment of the present disclosure:

FIG. 3A is a perspective illustration of a base according to an embodiment of the present disclosure;

FIG. 3B is another perspective illustration of the base of FIG. 3A according to an embodiment of the present disclosure:

FIG. 3C is a partial view of the base of FIG. 3A according to an embodiment of the present disclosure:

FIG. 3D is an exploded view of the base of FIG. 3A according to an embodiment of the present disclosure:

FIG. 4A schematically illustrates use of a sample delivery tool to deliver a sample to a fluidic single-use disposable according to an embodiment of the present disclosure:

FIG. 4B schematically illustrates coupling the fluidic single-use disposable of FIG. 4A to a base according to an embodiment of the present disclosure:

FIG. 4C schematically illustrates testing the sample with the fluidic single-use disposable and base of FIGS. 4A and 4B according to an embodiment of the present disclosure:

FIG. 4D schematically illustrates displaying results of the test of FIG. 4C with a smart phone according to an embodiment of the present disclosure:

FIG. 5A is a side view of coupling a first base with a second base according to an embodiment of the present disclosure:

FIG. 5B is a perspective view of the first base coupled to the second base of FIG. 5A where a first fluidic single-use disposable is coupled to the first base and a second fluidic single-use disposable is coupled to the second base according to an embodiment of the present disclosure:

FIGS. 5C and 5D are side views of an inter base electrical connection according to an embodiment of the present disclosure:

FIGS. 6A-6C illustrate sequentially inserting a sample delivery tool into a sample processing chamber, thereby actuating a rehydration subcomponent to place a puncturable fluid reservoir of the rehydration subcomponent in fluid communication with the sample processing chamber, according to an embodiment of the present disclosure:

FIG. 7A illustrates a plan view of a fluidics network comprising a plurality of fluidically isolated pathways according to an embodiment of the present disclosure:

FIG. 7B graphically illustrates fluorescence of a real-time loop-mediated isothermal amplification (RT LAMP) of a sample on a diagnostic system comprising the fluidics network of FIG. 7A, according to an embodiment of the present disclosure: and

FIG. 7C is a series of sequential images of the fluidics network of FIG. 7A during the reaction graphically illustrated in FIG. 7B, according to an embodiment of the present disclosure.

### DETAILED DESCRIPTION

Embodiments of a diagnostic system for analyzing one or more analytes is described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In an aspect, the present disclosure provides a diagnostic system for analyzing an analyte. In an embodiment, the diagnostic system comprises a fluidic single-use disposable, or “cartridge,” and a base, or “hub.” In an embodiment, the fluidic single-use disposable is configured to test a single sample, such as a single biological sample, at which point it may be disposed of.

As shown and described further herein, the design of the system has a small form factor configured for easy storage and transport. In an embodiment, the cartridge is configured to minimize or reduce user steps relative to conventional lab-based devices and methods by automatically rehydrating reagents and transferring a sample to a test area. In an embodiment, a battery disposed in the hub is configured to enable a test to be completed on battery power once started. Further, in an embodiment, the hub includes a screen to give feedback to the user and is controlled via a companion app.

While the fluidic single-use disposable or cartridge is generally described as being suitable for testing a single sample, as described further herein, the base or hub may be used numerous times to perform numerous tests using numerous fluidic single-use disposables or cartridges. In this regard, relatively more expensive components, such as optics, light sources, computing, and the like can be disposed in the base, whereas components configured to contact the sample are disposed in the fluidic single-use disposable. In this way, the reusable components do not contact a biological sample, which might otherwise require these reusable components to be discarded or cleaned and decontaminated after a single use.

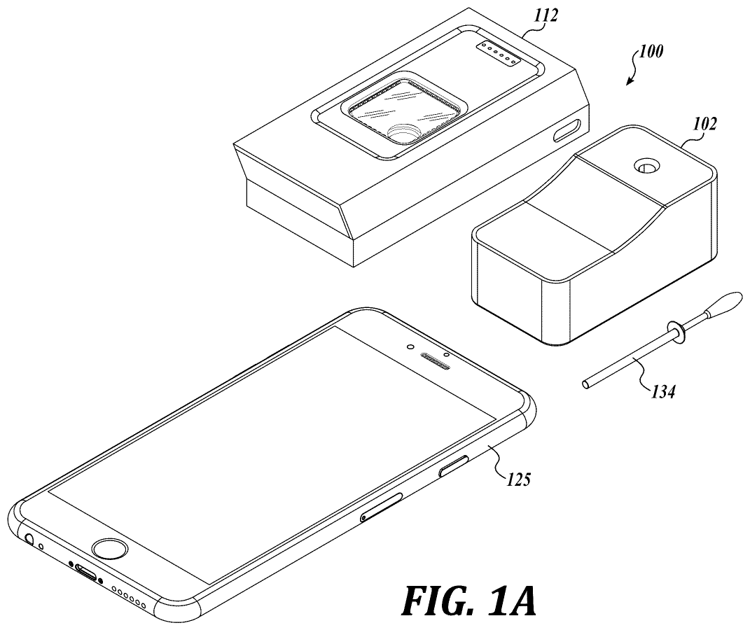

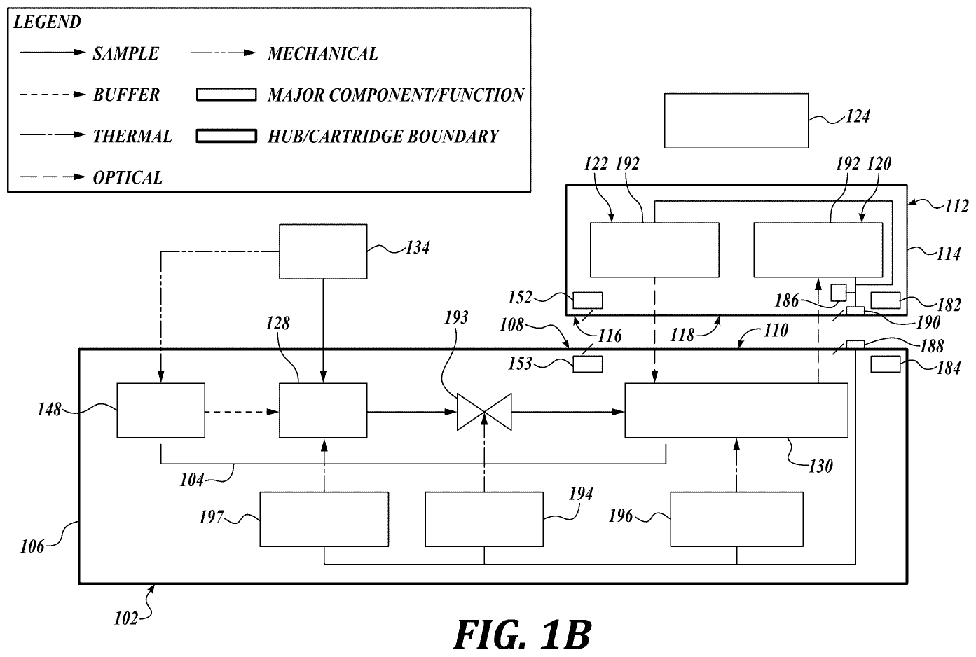

In this regard, attention is directed to FIGS. 1A and 1B in which a diagnostic system 100 according to an embodiment of the present disclosure is illustrated. FIG. 1A is an illustration of a diagnostic system 100 according to an embodiment of the present disclosure. FIG. 1B is a schematic illustration of a diagnostic system 100 according to an embodiment of the present disclosure. In an embodiment, the diagnostic system 100 of FIG. 1B is an example of the diagnostic system 100 of FIG. 1A.

In the illustrated embodiment of FIG. 1A, the diagnostic system 100 is shown to include a fluidic single-use disposable 102, a base 112, and a sample delivery tool 134. As discussed further herein, the fluidic single-use disposable 102 is shaped to couple with the base 112 such that light emitted or reflected from within the fluidic single-use disposable 102 is received by the base 112, in particular a photodetector 120 within the base housing 114.

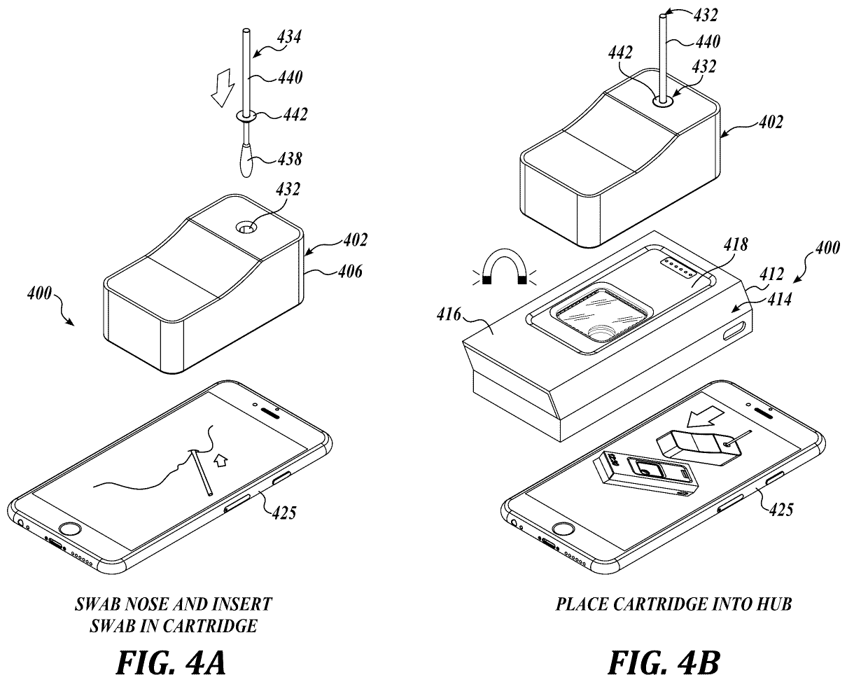

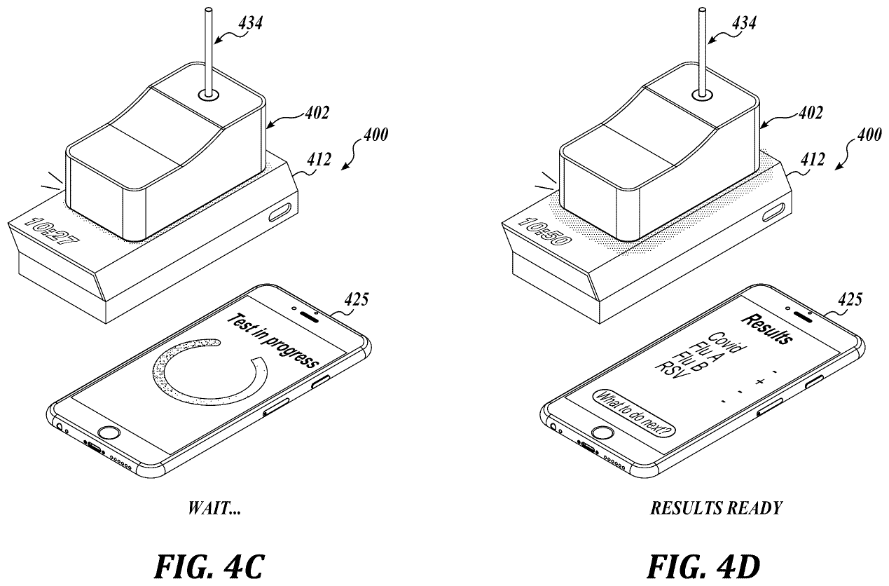

The diagnostic system 100 is shown to further include a smart phone 125. As discussed further herein with respect to FIGS. 4A-4D, the base 112 is configured to exchange signals between the base 112 and the phone 125, such as through operation of an app on the smart phone 125, to choreograph operation of the base 112 in performing a diagnostic assay and to display status and results of the diagnostic assay. While the diagnostic assay is shown to include the smart phone 125, in an embodiment diagnostic system 100 does not comprise a phone 125. In this regard, in an embodiment, the base 112 comprises a display or other structure or structures to display status and/or results of the diagnostic assay. Similarly, while a smart phone 125 is illustrated and discussed, it will be understood that other display devices, such as a tablet, personal computer, television, and the like, can be used for similar or analogous purposes, and are within the scope of the present disclosure. In a further embodiment, the base 112 sends information directly to a remote site for analysis. Information as a result of the analysis may then be sent to the patient, operator, caregiver, or a combination thereof.

Turning to FIG. 1B, a schematic side view of the diagnostic system 100 is illustrated. As shown, the diagnostic system 100 is shown to include a fluidic single-use disposable 102 and a base 112 coupled thereto.

In the illustrated embodiment, the fluidic single-use disposable 102 is shown to include a sample processing subcomponent 104 configured to receive a sample and emit signal light if the sample comprises an analyte: a fluidic single-use disposable housing 106 encompassing the sample processing subcomponent 104, the fluidic single-use disposable housing 106 comprising: a first major side 108: and a fluidic single-use disposable viewing window 110 disposed in the first major side 108 and positioned to allow light emitted from the sample processing subcomponent 104 to pass through the fluidic single-use disposable viewing window 110. In an embodiment, the sample processing subcomponent 104 is configured to alter signal light emitted therefrom.

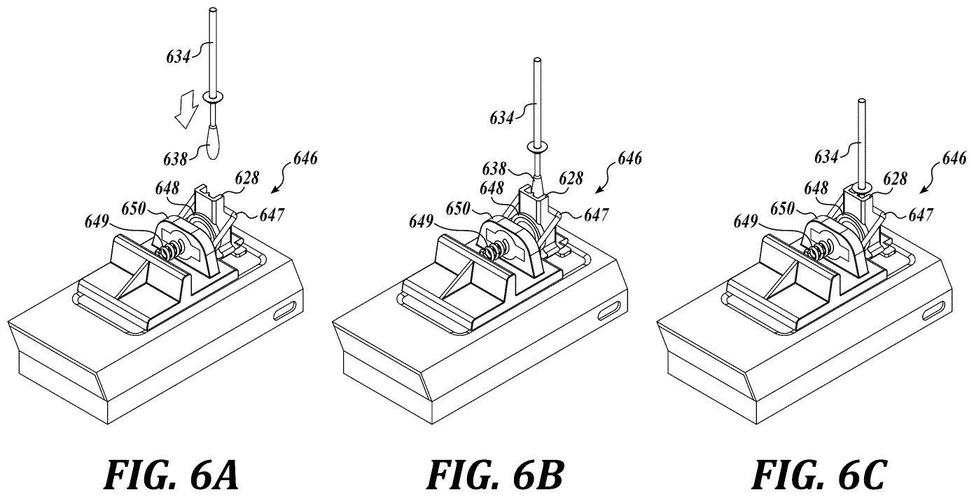

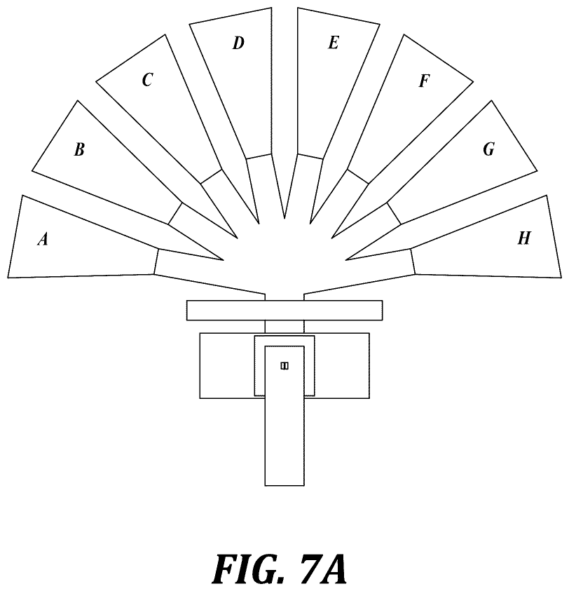

In the illustrated embodiment, sample processing subcomponent 104 is shown to include a puncturable fluid reservoir 148 in selective fluid communication with a sample processing chamber 128. As discussed further herein with respect to FIGS. 6A-6C, actuating components of the sample processing subcomponent 104 places the puncturable fluid reservoir 148 in fluid communication with the sample processing chamber 128 through receipt of the sample delivery tool 134.

In the illustrated embodiment, the fluidic single-use disposable 102 further comprises a valve 193, such as a heat shrink valve 193 fluidically isolating the sample processing chamber 128 from the fluidics network 130, when the heat shrink valve 193 is in a closed configuration. In an embodiment, the fluidics network 130 is fluidically coupled to the sample processing chamber 128, wherein the fluidics network 130 comprises detection reagents configured to couple with an analyte and to emit the signal light when coupled to the analyte. In the illustrated embodiment, the fluidics network 130 is positioned to emit the signal light through the fluidic single-use disposable viewing window 110, such as for receipt by the base 112 when the base 112 is coupled to the fluidic single-use disposable 102.

In an embodiment, the fluidics network 130 comprises a porous network configured to move a fluid sample through the porous network 130, such as through capillary action. In an embodiment, the fluidic network 130 comprises one or more porous materials selected from paper, glass wool, and the like.

As above, the diagnostic system 100 includes a base 112. In the illustrated embodiment, the base 112 comprises a base housing 114 comprising: a first major side 116 shaped to cooperatively couple with the first major side 108 of the fluidic single-use disposable housing 106: a base viewing window 118 disposed in the first major side 116 positioned to allow light emitted or reflected from the fluidic single-use disposable viewing window 110 to pass through the base viewing window 118 when the fluidic single-use disposable 102 is cooperatively coupled to the base 112: a photodetector 120 positioned to receive light emitted through the base viewing window 118 and configured to generate a detection signal based on light received by the photodetector 120 through the base viewing window 118; and a light source 122 configured to emit illumination light through the base viewing window 118 for receipt by the processing subcomponent on the fluidic single-use disposable 102.

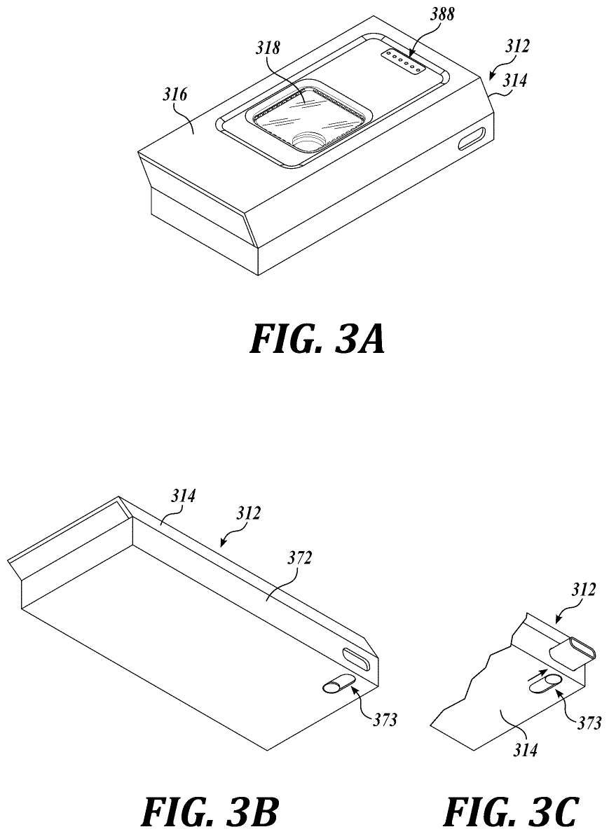

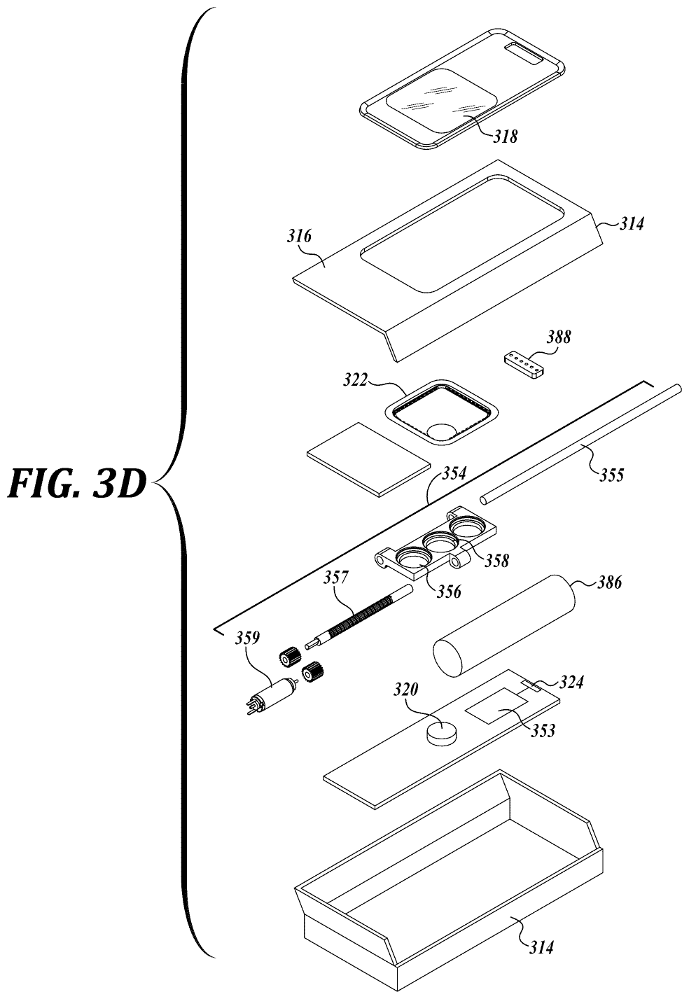

In an embodiment, the base 112 is configured to detect the fluidic single-use disposable 102 and send electrical signals to the fluidic single-use disposable 102 to facilitate the test (e.g., turning heaters on and off), select the appropriate emission filter and excitation LEDs, image the detection area on the fluidic single-use disposable 102 and transmit images or other detection data, such as to a cloud service, for interpretation. In this regard, the fluidic single-use disposable 102 comprises an identifier 152 indicative of an identity of the fluidic single-use disposable 102, and the base 112 comprises a detector 153 configured to generate a signal based upon the identity of the fluidic single-use disposable 102. As discussed further herein with respect to, for example, FIG. 3D, in an embodiment, the base 112 comprises a filter subcomponent positioned between the base viewing window 118 and the photodetector 120, wherein the filter subcomponent is configured to filter light received through the base viewing window 118, such as a filter subcomponent configured to selectively place different filters between the base viewing window 118 and the photodetector 120, such as based upon an identity of the fluidic single-use disposable 102 as indicated by the identifier 152.

As shown, the diagnostic system 100 is shown to include a controller 124. In an embodiment, the controller 124 operatively coupled to various electronic components of the diagnostic system 100, such as the photodetector 120 and the light source 122, to choreograph their operation. In this regard, in an embodiment, the controller 124 includes logic that, when executed by the controller 124, causes the diagnostic system 100 to perform operations. In an embodiment, these operations include emitting light with the light source 122: and generating a detection signal with the photodetector 120 based on light received through the base viewing window 118. In this regard, fluorescence or other detectable optical signals emitted from the fluidics network 130 as a result of illumination from the light source 122 can be received by the photodetector 120.

In the illustrated embodiment, the controller 124 is shown separate from either the base 112 or the fluidic single-use disposable 102. The controller 124 can be disposed in the base 112. The controller 124 is a functional element that choreographs and controls the operation of the other functional elements. In one embodiment, controller 124 is implemented with hardware logic (e.g., application specific integrated circuit, field programmable gate array, etc.). In yet another embodiment, controller 124 may be implemented as a general-purpose microcontroller that executes software or firmware instructions stored in memory (e.g., non-volatile memory, etc.). Yet alternatively, controller 124 may be implemented in a combination of hardware and software and further may be centralized or distributed across multiple components.

In the illustrated embodiment, the diagnostic system 100 is shown to include a power source 186 for providing electrical power to various electrical components 192 operably coupled thereto. In the illustrated embodiment, the power source 186 is shown disposed within the base 112. In an embodiment, the power source 186 is or comprises a battery. While a power source 186 is shown within the base 112, in an embodiment, the diagnostic system 100 is configured to conductively couple to an external power source 186.

In the illustrated embodiment, the base 112 is shown to include a base electrical communications port 188 conductively coupled to the power source 186. As shown, the fluidic single-use disposable 102 further comprises a fluidic single-use disposable electrical communications port 190 and one or more electrical components 192 conductively coupled to the fluidic single-use disposable electrical communications port 190. In the illustrated embodiment, the base 112 and the fluidic single-use disposable 102 are configured to place the fluidic single-use disposable electrical communications port 190 and the base electrical communications port 188 in conductive contact and to place the power source 186 in conductive contact with the one or more electrical components 192 when the base 112 and the fluidic single-use disposable 102 are cooperatively coupled. In this regard, the power source 186 is configured to power the one or more electrical components 192 in the fluidic single-use disposable 102, as well as those disposed in the base 112, such as the light source 122 and the photodetector 120.

As shown, the fluidic single-use disposable 102 comprises a number of electric and/or electronic components. In an embodiment, the one or more electrical components 192 are selected from the group consisting of a heater, a thermal detector, a fluid detector, a motor, and combinations thereof. In the illustrated embodiment, these components include a lysis heater 197 positioned and configured to provide heat to the sample processing chamber 128, such as to lyse cells disposed in the sample processing chamber 128: a valve heater 194 positioned and configured to provide heat to the heat shrink valve 193, such as to open the valve 193 to place the sample processing chamber 128 in fluid communication with the fluidics network 130; and an amplification heater 196 positioned and configured to provide heat to the fluidics network 130, such as suitable to perform a nucleic acid amplification reaction in the fluidics network 130.

In an embodiment, the contents of the sample processing chamber 128 are heated to 95° C., using the lysis heater 197. In an embodiment, the lysis heater 197 wraps around sides of the sample processing chamber 128 to provide distributed, even heating. In an embodiment, the sample is held at temperature in the sample processing chamber 128 for at least 3 minutes or at another temperature for a time sufficient to lyse cells in the sample.

In an embodiment, amplification occurs in the fluidics network 130 at approximately 60° C. In an embodiment, amplification does not begin until the sample has had ample time to transfer along the fluidics network 130.

In an embodiment, the base 112 and the fluidic single-use disposable 102 are configured to cooperatively couple, such as with one or more magnets. In this regard, in an embodiment and as shown, the fluidic single-use disposable 102 comprises a first magnet 182, wherein the base 112 comprises a second magnet 184, wherein the first magnet 182 and the second magnet 184 are configured to cooperatively couple the fluidic single-use disposable 102 and the base 112. In the illustrated embodiment, the first magnet 182 and the second magnet 184 are configured to orient the fluidic single-use disposable 102 and the base 112 when cooperatively coupled such that the light source 122 is configured to emit illumination light through the base viewing window 118 for receipt by the processing subcomponent on the fluidic single-use disposable 102: and the photodetector 120 is positioned to receive light emitted through the base viewing window 118. In this regard, the photodetector 120 is configured to detect a signal, such as a fluorescent signal, from the fluidics network 130 to analyze the analyte when the fluidic single-use disposable 102 and base 112 are cooperatively coupled.

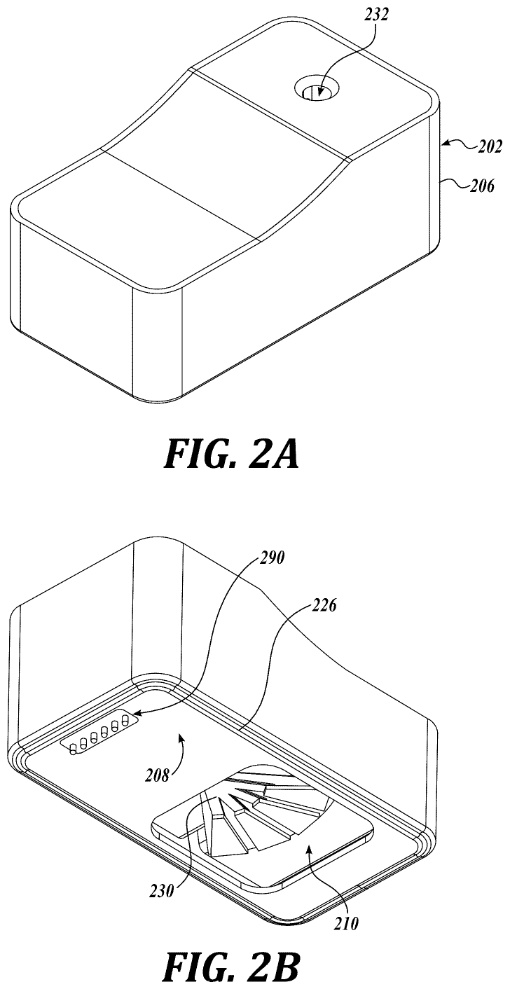

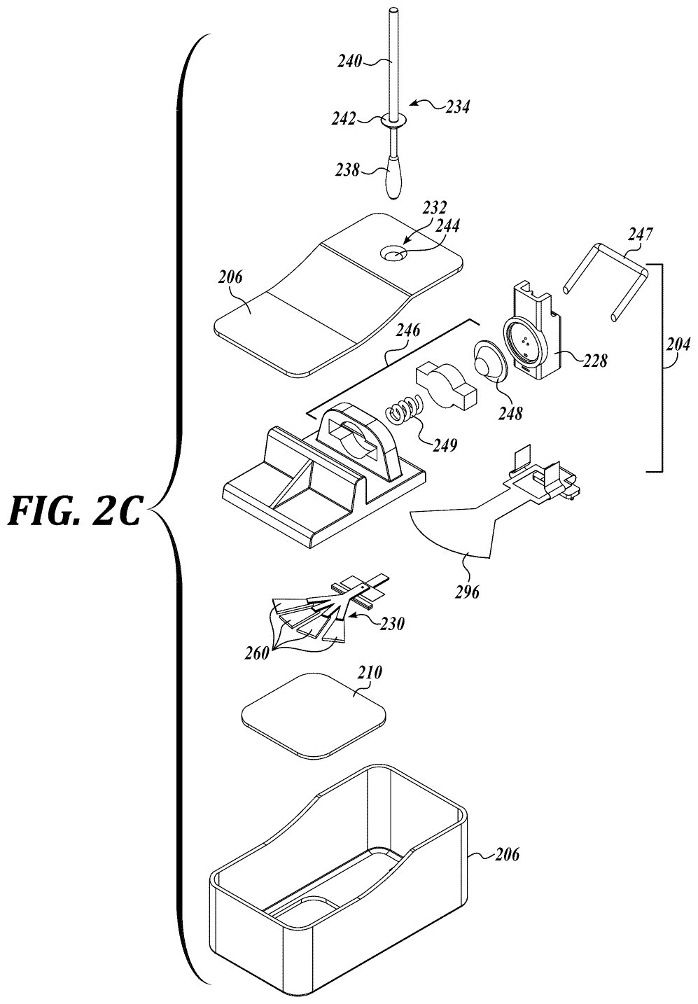

Turning now to FIGS. 2A-2C, a fluidic single-use disposable 202 according to embodiments of the present disclosure will now be described. In an embodiment, the fluidic single-use disposable 202 is an example of the fluidic single-use disposable 102 discussed further herein with respect to FIGS. 1A and 1B.

In the illustrated embodiment, the fluidic single-use disposable 202 comprises a sample processing subcomponent 204 configured to receive a sample and emit signal light if the sample comprises an analyte: a fluidic single-use disposable housing 206 encompassing the sample processing subcomponent 204, the fluidic single-use disposable housing 206 comprising a first major side 208: and a fluidic single-use disposable viewing window 210 disposed in the first major side 208 and positioned to allow light emitted from the sample processing subcomponent 204 to pass through the fluidic single-use disposable viewing window 210. As discussed further herein, the first major side 208 is configured to couple with a base, such as the base 112 described further herein with respect to FIGS. 1A and 1B.

In an embodiment, the fluidic single-use disposable housing 206 is opaque or is otherwise configured to limit or eliminate light entering into an interior portion of the fluidic single-use disposable housing 206. In this regard, light from an environment outside of the fluidic single-use disposable housing 206 does not enter into the interior portion, which might otherwise alter, skew; or obscure signal light from the fluidic single-use disposable 202 coupled to the base. Likewise, in an embodiment, the fluidic single-use disposable housing 206 comprises a gasket 226 disposed on the first major side 208 and configured to form a light-tight seal between the fluidic single-use disposable 202 and a base (not pictured, see, for example, FIG. 4C) when the fluidic single-use disposable 202 is cooperatively coupled to the base.

As shown in FIG. 2C, the sample processing subcomponent 204 comprises a sample processing chamber 228 shaped to receive a sample: and a fluidics network 230 fluidically coupled to the sample processing chamber 228, wherein the fluidics network 230 comprises detection reagents configured to couple with an analyte and to emit the signal light when coupled to the analyte. As shown in FIG. 2B, for example, the fluidics network 230 is positioned to emit the signal light through the fluidic single-use disposable viewing window 210. In this regard, when the fluidic single-use disposable 202 is coupled to the base, the fluidics network 230 is in a field of view of a base viewing window and photodetector disposed in the base. As shown, the fluidic single-use disposable 202 further comprises an amplification heater 296 positioned to heat the fluidics network 230, such as to perform an amplification reaction in the fluidics network 230.

As above, the sample processing subcomponent 204 comprises a sample processing chamber 228 shaped to receive a sample. In the illustrated embodiment, the fluidic single-use disposable housing 206 defines an aperture 232 shaped to receive a sample delivery tool 234. As shown, the sample processing chamber 228 is positioned to receive the sample delivery tool 234 through the aperture 232.

In the illustrated embodiment, the fluidic single-use disposable 202 comprises a sample delivery tool 234 for delivering a sample to the fluidic single-use disposable 202. As shown, the sample delivery tool 234 comprises a swab portion 238 configured to collect a sample, such as a nasal swab, and carry the sample for receipt by the aperture 232. The sample delivery tool 234 is shown to include a swab portion 238 configured to carry the sample: and a shaft 240 coupled to the swab portion 238. As shown, the shaft 240 defines a disc 242 shaped to occlude the aperture 232 when the shaft 240 is disposed within the aperture 232 and the swab portion 238 is received by the sample processing chamber 228. The disc 242 is shaped and positioned occlude the aperture 232 such that when sample delivery tool 234, such as the swab portion 238, is disposed in the sample processing chamber 228, the disc 242 prevents entry of other material through the aperture 232 such as might contaminate the sample.

In an embodiment, the disc 242 is shaped to prevent excess evaporation during lysis heating, such as heating of contents of the sample processing chamber 228 during lysis of the sample.

In an embodiment, the housing comprises a breakable seal 244 occluding the aperture 232, such as a breakable seal 244 configured to break when the aperture 232 receives the sample delivery tool 234. In this regard, the breakable seal 244 protects the fluidic single-use disposable 202 from contamination prior to use, such as in storage or shipping.

While a sample delivery tool 234 comprising a swab portion 238 is illustrated and discussed with respect to FIGS. 2A-2C, it will be understood that other sample delivery tools are possible and within the scope of the present disclosure. In this regard, in an embodiment, the sample delivery tool 234 comprises a pipette, wherein the aperture 232 is shaped to receive the pipette.

In an embodiment, the sample processing chamber 228 comprises lyophilized sample processing reagents. In an embodiment, the breakable seal 244 is configured to exclude moisture from the sample processing chamber 228 such that the lyophilized sample processing reagents remain lyophilized.

As shown, the fluidics network 230 defines a plurality of fluidically isolated fluidic pathways 260 in fluidic communication with the sample processing chamber 228. In an embodiment, each fluidically isolated pathway 260 is configured to receive a portion of the sample from the sample processing chamber 228.

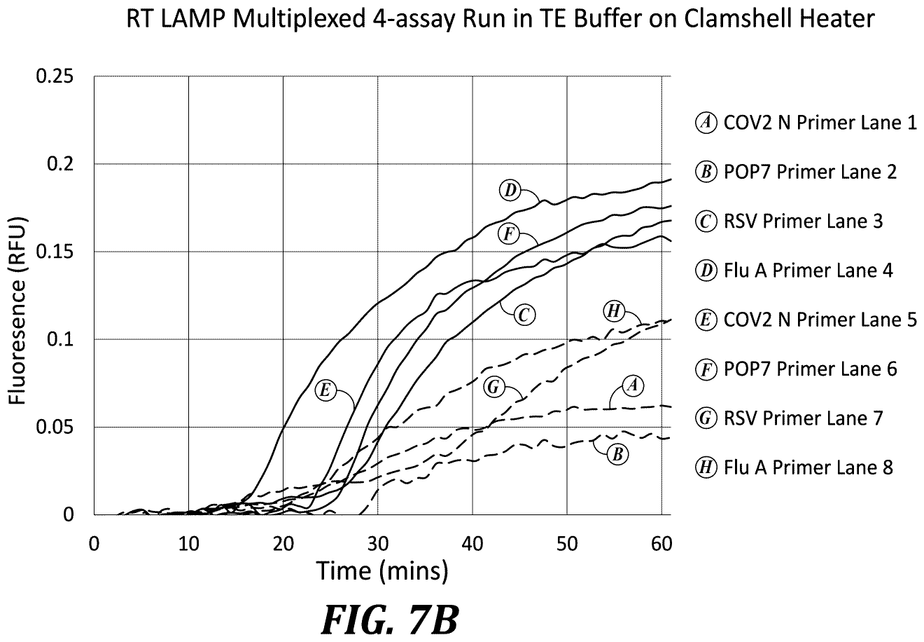

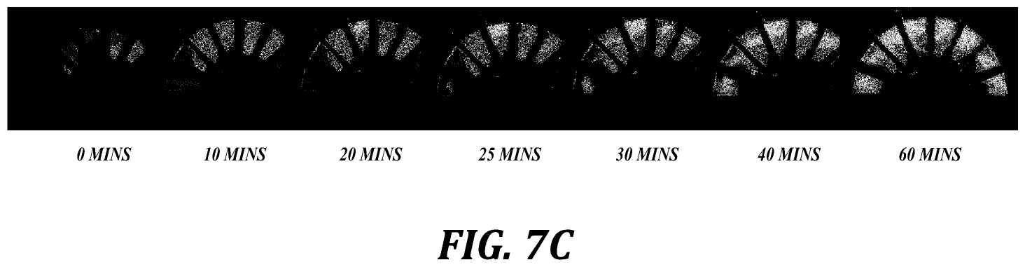

In an embodiment, each fluidically isolated fluidic pathway 260 of the plurality of fluidically isolated fluidic pathways 260 comprises detection reagents for coupling to an analyte and generating a signal when coupled to the analyte. In this regard, the fluidics network 230 is configured to detect a number of different analytes, such as COVID19, respiratory syncytial virus (RSV), influenza A, and influenza B, as described further herein with respect to FIGS. 7A-7C. In an embodiment, two or more of the plurality of fluidically isolated pathways 260 comprise detection reagents for coupling to the same analyte, such as wherein the detection reagents on the two or more fluidically isolated pathways 260 provide duplicate detection of the same analyte.

In an embodiment, the fluidic single-use disposable 202 includes a rehydration subcomponent 246 including a blister or puncturable fluid reservoir 248 in selective fluid communication with the sample processing chamber 228. In the illustrated embodiment, the fluidic single-use disposable 202 includes a blister or puncturable fluid reservoir 248 stored on a side of the sample processing chamber 228, which is biased by spring 249. As illustrated further herein with respect to FIGS. 6A-6C, in an embodiment, a sprung mechanism inside the fluidic single-use disposable 202 bursts the puncturable fluid reservoir 248 when the user inserts the sample delivery tool, rehydrating the lyophilized reagents. As shown, the sample processing subcomponent 204 comprises a link arm 247 hingedly coupled to the sample processing chamber 228.

FIGS. 6A-6C illustrate sequentially inserting a sample delivery tool 634 into a sample processing chamber 628, thereby actuating a rehydration subcomponent 646 to place a puncturable fluid reservoir 648 of the rehydration subcomponent 646 in fluid communication with the sample processing chamber 628, according to an embodiment of the present disclosure. As shown, rehydration subcomponent 646 comprises is shown to further include a link arm 647 hingedly coupled to the sample processing chamber 628.

As shown, rehydration subcomponent 646 comprises a puncturable fluid reservoir 648: and a structure 650 opposed to the puncturable fluid reservoir 648, the structure 650 configured to puncture the fluid reservoir to place the puncturable fluid reservoir 648 in fluid communication with the sample processing chamber 628. The spring 649 is biased to oppose motion of puncturable fluid reservoir 648 toward the structure 650, but yield when the sample delivery tool 634 is inserted into the sample processing chamber 628. In this regard, actuating the rehydration subcomponent 646 places the puncturable fluid reservoir 648 in fluid communication with the sample processing chamber 628 through receipt of the sample delivery tool 634.

In an embodiment, actuating the rehydration subcomponent 646 places the puncturable fluid reservoir 648 in fluid communication with the sample processing chamber 628 through receipt of the sample delivery tool 634, which rehydrates lyophilized lysis reagents as the swab portion 638 reaches the liquid level. In an embodiment, the rehydration subcomponent 646 is spring 649 controlled, releasing to squeeze the liquid out of the puncturable fluid reservoir 648 into the sample processing chamber 628. In an embodiment, an action force sufficient to actuate the rehydration subcomponent 646 is 30±15 N. Where a spring constant of the spring 649 is 5-10 N/mm, the spring 649 is preloaded between 1.5-9 mm.

Turning now to FIGS. 3A-3D, a base 312 according to an embodiment will now be described. In an embodiment, the base 312 is an example of base 112 discussed further herein with respect to FIGS. 1A and 1B. In an embodiment, base 312 is configured to couple with the fluidic single-use disposable 202 discussed further herein with respect to FIGS. 2A-2C, such as to form a light tight seal therebetween.

In the illustrated embodiment, the base 312 is shown to include a base housing 314 comprising a first major side 316: a base viewing window 318 disposed in the first major side 316 shaped to cooperatively couple with a first major side of a fluidic single-use disposable housing (not pictured, see, for example, FIGS. 2A-2C): a photodetector 320 positioned to receive light emitted through the base viewing window 318 and configured to generate a detection signal based on light received by the photodetector 320 through the base viewing window 318: and a light source 322 configured to emit illumination light through the base viewing window 318.

In an embodiment, the base viewing window 318 disposed in the first major side 316 is positioned to allow light emitted from a fluidic single-use disposable viewing window, such as viewing window 110 discussed further herein with respect to FIGS. 1A and 1B, to pass through the base viewing window 318 when a fluidic single-use disposable, such as fluidic single-use disposable 102, is cooperatively coupled to the base 312.

In an embodiment, the light source 322 is configured to emit illumination light through the base viewing window 318 for receipt by a processing subcomponent on a fluidic single-use disposable coupled to the base 312. In an embodiment, the base 312 includes excitation LEDs, shown in FIG. 3D as a ring of excitation LEDs with varying wavelength for test platformability built into the optical baffle.

In an embodiment, the base 312 includes a screen, such as a dot matrix screen formed by LEDs populated on a PCB. As shown in FIGS. 4A-4D, in an embodiment, the screen is configured to display results, assay time, etc.

As discussed further herein with respect to FIG. 1B, in an embodiment, the fluidic single-use disposable comprises an identifier indicative of an identity of the fluidic single-use disposable, and wherein the base 312 comprises a detector 353 configured to generate a signal based upon the identity of the fluidic single-use disposable coupled to the base 312.

As shown, the base 312 further comprises a filter subcomponent 354 positioned between the base viewing window 318 and the photodetector 320, wherein the filter subcomponent 354 is configured to filter light received through the base viewing window 318. In the illustrated embodiment, the filter subcomponent 354 comprises a first filter 356 configured to allow light of a first wavelength range to pass through the first filter 356; and a second filter 358 configured to allow light of a second wavelength range different than the first wavelength range to pass through the second filter 358. In an embodiment, the filter subcomponent 354 and the detector 353 are operatively coupled to the controller 324, where the controller 324 includes logic that, when executed by the controller 324, causes the base 312 to perform operations including positioning one of the first filter 356 and the second filter 358 to filter light received by the photodetector 320 based upon the identity of the fluidic single-use disposable. In this regard, light received by the photodetector 320 is based on an identity of the fluidic single-use disposable and, consequently, a test performed and analyte analyzed.

As shown, the filter subcomponent 354 includes a filter mechanism motor 359 and a lead screw 357. In operation, the filter mechanism motor 359 causes the first filter 356 and the second filter 358 to move relative to the photodetector 320, such that different wavelengths of light reach the photodetector 320 depending upon a position of the first filter 356 and second filter 358. In an embodiment, the base 312 includes a filter shuttle mechanism in which a motor 359 drives the lead screw 357 to move the shuttle backwards and forwards. In an embodiment, the shuttle contains a threaded boss and rotation is constrained by the guiderail 355. In an embodiment, the filter mechanism motor 359 is, for example, a stepper motor or a brushless DC motor with an encoder.

The base 312 is shown to include a power source 386, such as a battery configured to provide electrical power to various electrical components conductively coupled thereto. In the illustrated embodiment, the base 312 is also shown to include a base electrical communications port 388 conductively coupled to the power source 386.

As discussed further herein, in an embodiment, fluidic single-use disposables of the present disclosure, such as fluidic single-use disposable 202, include corresponding a fluidic single-use disposable electrical communications port: and one or more electrical components conductively coupled to the fluidic single-use disposable electrical communications port 390, such that the base 312 and the fluidic single-use disposable are configured to place the fluidic single-use disposable electrical communications port and the base electrical communications in conductive contact and to place the power source 386 in conductive contact with the one or more electrical components when the base 312 and the fluidic single-use disposable are cooperatively coupled.

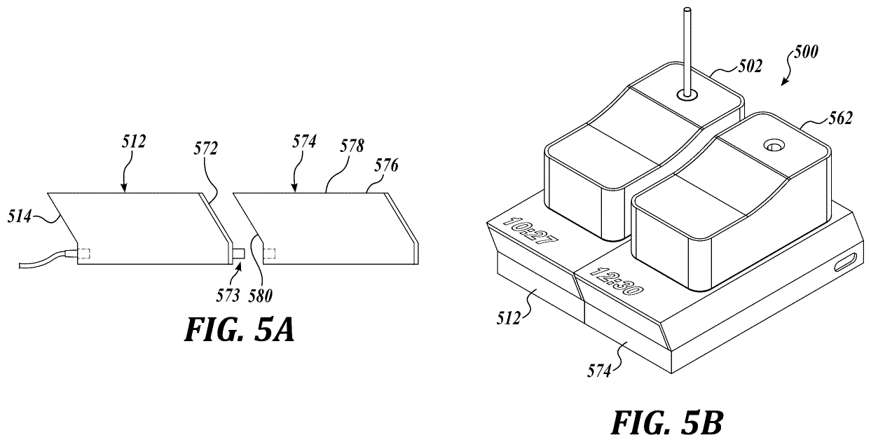

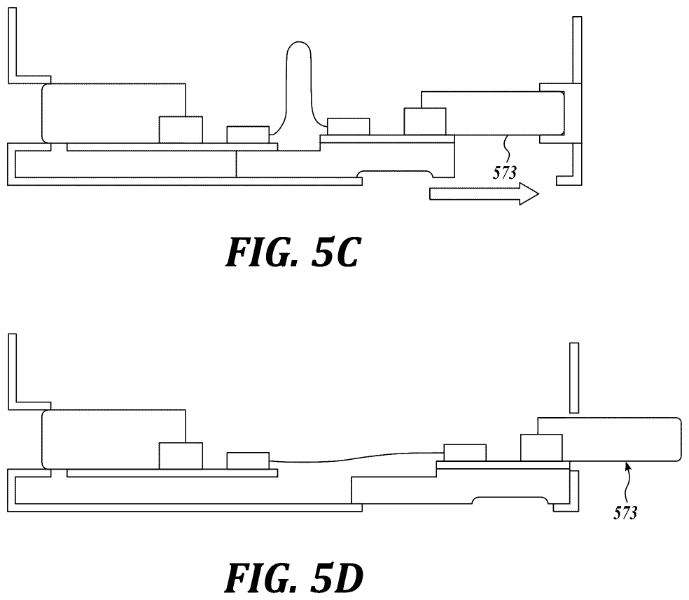

In an embodiment, the diagnostic systems of the present disclosure comprise two or more fluidic single-use disposables, such as two or more fluidic single-use disposables each configured to detect a different analyte. In an embodiment, the diagnostic systems of the present disclosure comprise two or more bases configured to couple together and configured to couple to the two or more fluidic single-use disposables. In this regard. attention is directed to FIGS. 5A-5D in which a diagnostic system 500 according to an embodiment of the present disclosure is illustrated. FIG. 5A is a side view of coupling a first base 512 with a second base 574. FIG. 5B is a perspective view of the first base 512 coupled to the second base 574 also coupled to a first fluidic single-use disposable 502 and a second fluidic single-use disposable 562. FIGS. 5C and 5D are side views of an inter base electrical connection.

As shown, the diagnostic system 500 comprises a first fluidic single-use disposable 502 for analyzing a first analyte, and a second fluidic single-use disposable 562 for analyzing a second analyte. In an embodiment, the first fluidic single-use disposable 502 and the second fluidic single-use disposable 562 are examples of the fluidic single-use disposables according to any embodiment of the present disclosure. In this regard, in an embodiment, the first fluidic single-use disposable 502 comprises a sample processing subcomponent configured to receive a sample and emit signal light if the sample comprises an analyte: a fluidic single-use disposable housing encompassing the sample processing subcomponent, the fluidic single-use disposable housing comprising a first major side: and a fluidic single-use disposable viewing window disposed in the first major side and positioned to allow light emitted from the sample processing subcomponent to pass through the fluidic single-use disposable viewing window, as discussed further herein with respect to, for example, FIGS. 2A-2C. Likewise, in an embodiment, the second fluidic single-use disposable 562 comprises a sample processing subcomponent configured to receive a sample and emit signal light if the sample comprises an analyte: a second fluidic single-use disposable housing comprises a first major side: and a fluidic single-use disposable viewing window disposed in the first major side and positioned to allow light emitted from the sample processing subcomponent to pass through the fluidic single-use disposable viewing window.

In an embodiment, the first major side of the second fluidic single-use disposable 562 is shaped to cooperatively couple with the first major side 578 of the second base 574.

In the illustrated embodiment, the diagnostic system 500 is shown to include a first base 512 defining a second major side: and a second base 574 comprising a second base housing 576. As shown, the second base 574 defines a first major side 578 shaped to cooperatively couple with the second fluidic single-use disposable housing: and a second major side 580 shaped to cooperatively couple with the second major side 572 of the first base 512. In this regard, the first base 512 and second base 574 are configured to cooperatively couple, such as to share electrical power and exchange signals. As shown in FIGS. 5C and 5D, the first base 512 comprises an inter-base electrical connection 573 and the second base 574 comprises a slot shaped to receive the inter-base electrical connection 573 and to receive electrical power therefrom. As also shown in FIGS. 5C and 5D, the inter-base electrical connection 573 is configured to slide out of the first base 512 housing to protrude from the first base housing 514 for receipt by the second base 574. See also FIG. 3C.

By coupling the first base 512 to the second base 574, the second base 574 can receive electrical power from the first base 512. Further, by also coupling the first fluidic single-use disposable 502 to the first base 512 and the second fluidic single-use disposable 562 is coupled to the second base 574, a first sample may be analyzed for the presence or absence of a first analyte and second sample may be analyzed for a second analyte, such as simultaneously analyzed for the first and second analytes. This is in addition to any multiplexing capabilities already present in the fluidics networks of either the first fluidic single-use disposable 502 or the second the fluidic single-use disposable due to an fluidically isolated fluidic pathways in the fluidics networks of the fluidic single-use disposables.

In an embodiment, the diagnostic system 500 includes a plurality of bases, which are configured to be daisy-chained, such as using USB-C connectors. This allows transfer of power and communication between bases. In an embodiment, each base includes one socket and one plug. In an embodiment, each base includes a USB-C socket, such as may be configured to provide external power supply (single base), external power supply (first base in chain), and connection to a previous base in the chain, connection to the next base in the chain, and where such a USB-C plug is concealed with a cover or base housing.

An example method of using a diagnostic system 400 according to embodiments of the present disclosure will now be described with respect to FIGS. 4A-4D. In an embodiment, the method illustrated is an example of using the diagnostic system 100 of FIGS. 1A and 1B. In an embodiment, the method illustrated is an example of a method of using the fluidic single-use disposable 202 of FIGS. 2A-2C. In an embodiment, the method illustrated is an example of a method of using the base 312 of FIGS. 3A-3D.

FIG. 4A illustrates inserting a sample delivery tool 434 into an aperture 432 of a fluidic single-use disposable 402, wherein the aperture 432 is defined by a housing of the fluidic single-use disposable 402. As shown, the sample deliver tool comprises a swab portion 438 configured to carry the sample: and a shaft 440 coupled to the swab portion 438, the shaft 440 defining a disc 442.

As also illustrated, the system includes a smart phone 425 displaying instructions for collecting a sample, here inserting the swab portion 438 into the nose of a subject.

FIG. 4B illustrates the sample delivery tool 434 disposed within the aperture 432 to introduce the sample collected in FIG. 4A into the fluidic single-use disposable 402, such as a sample processing subcomponent (not shown, see FIG. 2C). As shown, the disc 442 is shaped to occlude the aperture 432 when the shaft 440 is disposed within the aperture 432 and the swab portion 438 is received by the sample processing chamber.

As also shown, the fluidic single-use disposable 402 is shown coupled (here magnetically coupled) with a base 412. In the illustrated embodiment, the base 412 comprises a base housing 414 comprising a first major side 416 shaped to cooperatively couple with the first major side of the fluidic single-use disposable housing 406. The base 412 is also shown to include a base viewing window 418 disposed in the first major side 416 positioned to allow light emitted from a fluidic single-use disposable viewing window (not shown, see, for example, FIG. 2B) to pass through the base viewing window 418 when the fluidic single-use disposable 402 is cooperatively coupled to the base 412.

In FIG. 4B, the smart phone 425 is shown schematically illustrating cooperative coupling between the fluidic single-use disposable 402 and the base 412 by placing the first major side 416 of the base 412 with the first major side of the fluidic single-use disposable 402.

FIG. 4C schematically illustrates testing the sample with the fluidic single-use disposable 402 and base 412. As shown, the smart phone 425 indicates that testing is ongoing, displaying the words “Test in progress”. During testing, the sample may be lysed. transported to a fluidics network, and amplified, as discussed elsewhere herein.

FIG. 4D schematically illustrates displaying results of the test of FIG. 4C with the smart phone 425. As shown, the results illustrate results, both positive and negative, from individual tests of several analytes. As also shown, the smart phone 425 provides a button illustrated to read “What to do next?”. In an embodiment, when pressed by a user, the phone 425 directs the user to medication, care providers, and the like based upon the test results.

Certain processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible machine-readable storage medium includes any mechanism that provides (i.e., stores) information in a non-transitory form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the disclosure, including what is described in the Abstract, is not intended to be exhaustive or to limit the disclosure to the precise forms disclosed. While specific embodiments of, and examples for, the disclosure are described herein for illustrative purposes, various modifications are possible within the scope of the disclosure, as those skilled in the relevant art will recognize.

These modifications can be made to the disclosure in light of the above detailed description. The terms used in the following claims should not be construed to limit the disclosure to the specific embodiments disclosed in the specification. Rather, the scope of the disclosure is to be determined entirely by the following claims, which are to be construed in accordance with established doctrines of claim interpretation.

### EXAMPLES

### Example 1

A diagnostic device was prepared using laser-cut polymethyl methacrylate (PMMA) layers and bonded together using polydimethylsiloxane (PDMS), with the internal channels holding 8 QMA amplification membranes (Whatman) and a 2D paper network channel made of 8950 glass fiber (Ahlstrom) with 8 channels leading to each amplification membrane. Each QMA pad held lyophilized RT LAMP reaction mix for 1 of 4 assays (COVID, influenza A, RSV, and POP7 gene), for n=2 replicates for each assay across 8 pads. The RT LAMP reaction mix was composed of WarmStart LAMP mix (NEB), primer mix for corresponding assay, 10% trehalose, 0.5% dextran, 7.5 M SYTO-82, and 40 μM hydroxynaphthol blue (HNB). 500 μL of template solution, containing 2×10⁴ copies each of COVID inactivated virus, RSV virus, Flu virus, and genomic human DNA in TE buffer (10 mM Tris-HCl, 0.1 mM EDTA), was lysed at 95 C for 8 mins on a VWR heat plate and added to the lysis region to hydrate all QMA pads simultaneously. Each QMA pad had a volume capacity of 25 μL, resulting in 1000 copies of each virus/DNA per pad. Positive and negative controls for RT LAMP reagents were run concurrently on a BioRAD CFX 96-well real-time thermocycler in tubes. The device was sealed with MicroSeal B Seal (BioRad) and placed into a custom-made dual-sided heating oven with an ITO glass top heater and heated at 64 C for 60 minutes in a dark room. Imaging was performed using a Google Nexus 5× phone equipped with a custom fitted black PMMA fixture holding two interference filters: a FES0550 excitation Shortpass filter (Thorlabs) and BP 587/25 emission filter (Zeiss). A 12 mm wide, 12 mm focal length plano-convex lens (Edmund Optics) was placed 6 mm from the light-emitting diode to collimate the excitation light. The phone was fixed to a stand 8 cm above the amplification device. Images were taken every minute using the phone's incandescent white balance setting. ⅕ aperture, 200 ISO, and manually focused to 8 mm focal length. The intensity of selected regions in each paper pad during amplification curves were quantified using a custom MATLAB script that evaluates the intensity changes of the top 1% of pixel intensity within the selected QMA region of interest (ROI). The average background intensity from minutes 5-10 was subtracted from each image. The most rapidly brightening portions of each pad within each image were converted to a fluorescence intensity value to generate curves of the selected image intensity with time.

FIG. 7A illustrates the device layout containing four distinct RT LAMP assays (COVID, POP7 RSV, and Flu A), with n=2 replicates each. One replicate of each assay is placed in the center four lanes (lanes 3-6), and the other replicate is placed along the outer four lanes (Lanes 1-2, 7-8). This minimizes the fluorescent gradient across the four assays created by the angle of each pad relative to the phone fluorescent filters. One unified sample is divided 8 ways across all pads, with each pad receiving the same mixture of targets (RNA, DNA) from a common buffer. This enables simultaneous detection of up to 8 different assays from a single sample source (i.e., swab, saliva, blood)

FIG. 7C illustrates a sample run using the 8-plex device. The images show increasing fluorescent signal over the course of an hour as nucleic acid amplification occurs, indicating the assay on each pad is amplifying its corresponding target. The 8-plex resuspension from a single sample source ensures that every pad contains the same copy number of each target. The quantified fluorescent curves (See FIG. 7B) demonstrate simultaneous detection of signal from all 8 pads, demonstrating the viability of using a separate assay in each pad. Fiducial marks can be added to normalize quantified fluorescent values.

While illustrative embodiments have been illustrated and described, it will be appreciated that various changes can be made therein without departing from the spirit and scope of the disclosure.

1. A diagnostic system for analyzing an analyte, the diagnostic system comprising:
a fluidic single-use disposable comprising:
a sample processing subcomponent configured to receive a sample and emit signal light if the sample comprises an analyte:
a fluidic single-use disposable housing encompassing the sample processing subcomponent, the fluidic single-use disposable housing comprising:
a first major side; and
a fluidic single-use disposable viewing window disposed in the first major side and positioned to allow light emitted from the sample processing subcomponent to pass through the fluidic single-use disposable viewing window; and
a base comprising:
a base housing comprising:
a first major side shaped to cooperatively couple with the first major side of the fluidic single-use disposable housing:
a base viewing window disposed in the first major side positioned to allow light emitted from the fluidic single-use disposable viewing window to pass through the base viewing window when the fluidic single-use disposable is cooperatively coupled to the base:
a photodetector positioned to receive light emitted through the base viewing window and configured to generate a detection signal based on light received by the photodetector through the base viewing window; and
a light source configured to emit illumination light through the base viewing window for receipt by the processing subcomponent on the fluidic single-use disposable; and
a controller operatively coupled to the photodetector and the light source, the controller including logic that, when executed by the controller, causes the diagnostic system to perform operations including:
emitting light with the light source; and
generating a detection signal with the photodetector based on light received through the base viewing window.

2. The diagnostic system of claim 1, wherein the fluidic single-use disposable housing comprises a gasket disposed on the first major side and configured to form a light-tight seal between the fluidic single-use disposable and the base when the fluidic single-use disposable is cooperatively coupled to the base.

3. The diagnostic system of claim 1, wherein the sample processing subcomponent comprises:
a sample processing chamber shaped to receive the sample; and
a fluidics network fluidically coupled to the sample processing chamber, wherein the fluidics network comprises detection reagents configured to couple with the analyte and to emit the signal light when coupled to the analyte.

4. The diagnostic system of claim 3, wherein the fluidics network is positioned to emit the signal light through the fluidic single-use disposable viewing window.

5. The diagnostic system of claim 3, wherein the fluidic single-use disposable housing defines an aperture shaped to receive a sample delivery tool, and wherein the sample processing chamber is positioned to receive the sample delivery tool through the aperture.

6. The diagnostic system of claim 5, further comprising a sample delivery tool for delivering the sample to the fluidic single-use disposable.

7. The diagnostic system of claim 6, wherein the sample delivery tool comprises a pipette, wherein the aperture is shaped to receive the pipette.

8. The diagnostic system of claim 6, wherein the sample delivery tool comprises:
a swab portion configured to carry the sample; and
a shaft coupled to the swab portion, the shaft defining a disc shaped to occlude the aperture when the shaft is disposed within the aperture and the swab portion is received by the sample processing chamber.

9. The diagnostic system of claim 3, wherein the sample processing chamber comprises lyophilized sample processing reagents, and wherein the housing comprises a breakable seal occluding the aperture.

10. The diagnostic system of claim 9, further comprising a rehydration subcomponent comprising:
a puncturable fluid reservoir: and
a structure opposed to the puncturable fluid reservoir, the structure configured to puncture the fluid reservoir to place the puncturable fluid reservoir in fluid communication with the sample processing chamber.

11. The diagnostic system of claim 10, wherein actuating the rehydration subcomponent places the puncturable fluid reservoir in fluid communication with the sample processing chamber through receipt of the sample delivery tool.

12. The diagnostic system of claim 1, wherein the fluidic single-use disposable comprises an identifier indicative of an identity of the fluidic single-use disposable, and wherein the base comprises a detector configured to generate a signal based upon the identity of the fluidic single-use disposable.

13. The diagnostic system of claim 12, wherein the base further comprises a filter subcomponent positioned between the base viewing window and the photodetector, wherein the filter subcomponent is configured to filter light received through the base viewing window.

14. The diagnostic system of claim 13, wherein the filter subcomponent comprises:
a first filter configured to allow light of a first wavelength range to pass through the first filter; and
a second filter configured to allow light of a second wavelength range different than the first wavelength range to pass through the filter;
wherein the filter subcomponent and the detector are operatively coupled to the controller, the controller further including logic that, when executed by the controller, causes the base to perform operations including:
positioning one of the first filter and the second filter to filter light received by the photodetector based upon the identity of the fluidic single-use disposable.

15. The diagnostic system of claim 3, wherein the fluidics network defines a plurality of fluidically isolated fluidic pathways in fluidic communication with the sample processing chamber, wherein each fluidically isolated fluidic pathway of the plurality of fluidically isolated fluidic pathways comprises detection reagents for coupling to an analyte and generating a signal when coupled to the analyte.

16. The diagnostic system of claim 1, wherein the fluidic single-use disposable is a first fluidic single-use disposable, and the analyte is a first analyte, and wherein the diagnostic system further comprises a second fluidic single-use disposable for analyzing a second analyte.

17. The diagnostic system of claim 16, wherein the second fluidic single-use disposable comprises:
a sample processing subcomponent configured to receive a second sample and emit signal light if the sample comprises an analyte:
a second fluidic single-use disposable housing comprises:
a first major side; and
a fluidic single-use disposable viewing window disposed in the first major side and positioned to allow light emitted from the sample processing subcomponent to pass through the fluidic single-use disposable viewing window.

18. The diagnostic system of claim 17, wherein the first major side of the second fluidic single-use disposable is shaped to cooperatively couple with the first major side of the base.

19. The diagnostic system of claim 17, wherein the base is a first base defining a second major side, the diagnostic system further comprising a second base comprising a second base housing defining:
a first major side shaped to cooperatively couple with the second fluidic single-use disposable housing: and
a second major side shaped to cooperatively couple with the second major side of the first base.

20. The diagnostic system of claim 1, wherein the fluidic single-use disposable comprises a first magnet, wherein the base comprises a second magnet, wherein the first magnet and the second magnet are configured to cooperatively couple the fluidic single-use disposable and the base.

21. The diagnostic system of claim 20, wherein the first magnet and the second magnet are configured to orient the fluidic single-use disposable and the base when cooperatively coupled such that:
the light source is configured to emit illumination light through the base viewing window for receipt by the processing subcomponent on the fluidic single-use disposable; and
the photodetector is positioned to receive light emitted through the base viewing window.

22. The diagnostic system of claim 1, wherein the base further comprises:
a power source; and
a base electrical communications port conductively coupled to the power source:
wherein the fluidic single-use disposable further comprises:
a fluidic single-use disposable electrical communications port:
one or more electrical components conductively coupled to the fluidic single-use disposable electrical communications port,
wherein the base and the fluidic single-use disposable are configured to place the fluidic single-use disposable electrical communications port and the base electrical communications in conductive contact and to place the power source in conductive contact with the one or more electrical components when the base and the fluidic single-use disposable are cooperatively coupled.

23. The diagnostic system of claim 22, wherein the one or more electrical components are selected from the group consisting of a heater, a thermal detector, a fluid detector, a motor, and combinations thereof.

24. The diagnostic system of claim 1, wherein the photodetector of the base comprises a camera configured to generate images of the fluidic single-use disposable.
